(19) United States
(12) Patent Application Publication
(10) Pub. No.: US 2024/0023215 A1
(43) Pub. Date: Jan. 18, 2024

(54) MULTI-FUNCTION LIGHTING DEVICE

(71) Applicant: Xiamen PVTECH Co., Ltd., Xiamen (CN)

(72) Inventors: FUXING LU, Xiamen (CN); RONGTU LIU, Xiamen (CN); GUOHUA ZHOU, Xiamen (CN)

(73) Assignee: Xiamen PVTECH Co., Ltd., Xiamen (CN)

(21) Appl. No.: 17/982,541

(22) Filed: Nov. 8, 2022

(30) Foreign Application Priority Data
Jul. 13, 2022 (CN) 202210827086.X

(51) Int. Cl. F21V 23/04; H05B 47/17

(52) U.S. Cl. CPC F21V 23/04; H05B 47/17

(57) ABSTRACT

A multi-function lighting device includes a controller, a first switch, a second switch, a third switch, a fourth switch and a light source group including a first light source and a second light source. The three ends of the first switch are connected to the controller, a driving power source and a first node respectively. The three ends of the second switch are connected to the controller, the first node and a grounding point respectively. The three ends of the third switch are connected to the controller, the driving power source and a second node respectively. The three ends of the fourth switch are connected to the controller, the second node and the grounding point respectively. The light source group is connected to the first node and the second node.

### BACKGROUND OF THE INVENTION

### 1. Field of the Invention

The present invention relates to a lighting device, in particular to a multi-function lighting device.

### 2. Description of the Prior Art

Most currently available lighting devices usually provide only step-dimming function, but cannot provide stepless dimming function, so the application thereof is limited. Thus, another type of lighting devices is developed in order to provide both stepless dimming function and color temperature adjustment function. However, this type needs at least two driving power sources. Besides, the circuit structure of this type is very complicated, so the cost thereof is also significantly increased.

### SUMMARY OF THE INVENTION

One embodiment of the present invention provides a multi-function lighting device, which includes a controller, a first switch, a second switch, a third switch, a fourth switch and a light source group. The first end, the second end and the third end of the first switch are connected to the controller, a driving power source and a first node respectively. The first end, the second end and the third end of the second switch are connected to the controller, the first node and a grounding point respectively. The first end, the second end and the third end of the third switch are connected to the controller, the driving power source and a second node respectively. The first end, the second end and the third end of the fourth switch are connected to the controller, the second node and the grounding point respectively. The light source group includes a first light source and a second light source. The positive electrode of the first light source and the negative electrode of the second light source are connected to the first node. The negative electrode of the first light source and the positive electrode of the second light source are connected to the second node.

In one embodiment of the present invention, the first switch, the second switch, the third switch and the fourth switch are bipolar junction transistors (BJT).

In one embodiment of the present invention, the controller is a microcontroller unit (MCU), a central-processing unit (CPU), an application specific integrated circuit (ASIC) or a field programmable gate array (FPGA).

In one embodiment of the present invention, when the controller generates a second control signal inputted into the second switch and the third switch is high-level, the second switch and the third switch are turned on so as to turn on the second light source. When the second control signal is low-level, the second switch and the third switch are turned off so as to turn off the second light source.

In one embodiment of the present invention, the waveform of the first control signal is complementary to the waveform of the second control signal.

In one embodiment of the present invention, the first control signal and the second control signal are pulse-width modulation (PWM) signals.

In one embodiment of the present invention, the controller adjusts the first control signal and the second control signal to change the off time of the light source group in order to adjust the brightness of the light source group.

In one embodiment of the present invention, the controller adjusts the duty cycle of the first control signal and/or the duty cycle of the second control signal in order to change the color temperature of the light emitted by the light source group.

In one embodiment of the present invention, the first light source and the second light source are light-emitting diodes (LED) or LED arrays.

The multi-function lighting device in accordance with the embodiments of the present invention may have the following advantages:
(1) In one embodiment of the present invention, the multi-function lighting device includes the light source group having the first light source and the second light source. The positive electrode of the first light source and the negative electrode of the second light source are connected to the first node, and the negative electrode of the first light source and the positive electrode of the second light source are connected to the second node. Thus, the first light source and the second light source can be connected to each other in inverse parallel connection. In this way, the controller can adjust the first control signal and the second control signal (the waveform of the first control signal is complementary to the waveform of the second control signal) in order to adjust the brightness and/or color temperature of the light source group. Accordingly, the multi-function lighting device can provide both the brightness adjustment function and color temperature adjustment function.
(2) In one embodiment of the present invention, the controller of the multi-function lighting device can adjust the first control signal and the second control signal by executing a software (the waveform of the first control signal is complementary to the waveform of the second control signal) so as to realize the stepless dimming function and/or the color temperature adjustment function. Therefore, the performance of the multi-function lighting device can be further enhanced.
(3) In one embodiment of the present invention, the light source group of the multi-function lighting device has a first light source and a second light source connected to each other in inverse parallel connection. Thus, the size of the light source group can be reduced, such that the circuit board can have more space for other electronic components and wires.
(4) In one embodiment of the present invention, the multi-function lighting device can integrate the light source group, the first switch, the second switch, the third switch and the fourth switch with each other via a full-bridge circuit. Therefore, the above circuit structure can be driven by one driving power source rather than multiple driving power sources. Thus, the cost of the multi-function lighting device can be further decreased.
(5) In one embodiment of the present invention, the multi-function lighting device can be driven by one driving power source rather than multiple driving power sources. Therefore, the cost of the multi-function lighting device can be effectively decreased, so the multi-function lighting device can achieve great market competitiveness.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a circuit diagram of a multi-function lighting device in accordance with one embodiment of the present invention.

FIG. 2 is a first schematic view of an operational state of the multi-function lighting device in accordance with one embodiment of the present invention.

FIG. 3 is a second schematic view of the operational state of the multi-function lighting device in accordance with one embodiment of the present invention.

FIG. 4 is a schematic view for illustrating a first control signal and a second control signal of the multi-function lighting device in accordance with one embodiment of the present invention.

FIG. 5 is a flow chart of a manufacturing method of the multi-function lighting device in accordance with one embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

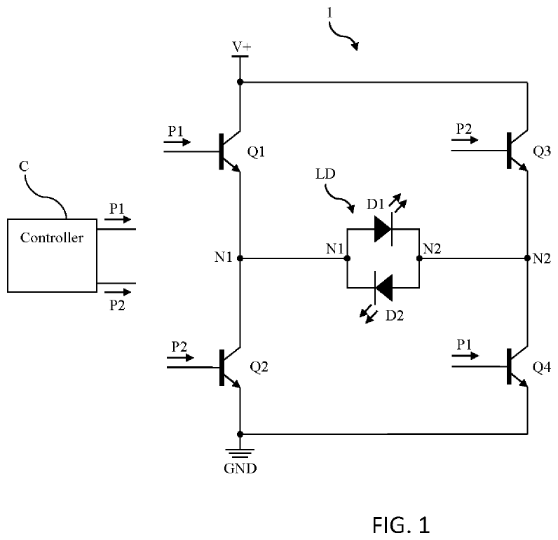

Please refer to FIG. 1, which is a circuit diagram of a multi-function lighting device in accordance with one embodiment of the present invention. As shown in FIG. 1, the multi-function lighting device 1 includes a controller C, a first switch Q1, a second switch Q2, a third switch Q3, a fourth switch Q4 and a light source group LD. In the embodiment, the controller C may be a microcontroller unit (MCU). In another embodiment, the controller C may be a central-processing unit (CPU), an application specific integrated circuit (ASIC), a field programmable gate array (FPGA) or other similar components. In the embodiment, the first switch Q1, the second switch Q2, the third switch Q3 and the fourth switch Q4 may be bipolar junction transistors (BJT). In another embodiment, the first switch Q1, the second switch Q2, the third switch Q3 and the fourth switch Q4 may be other currently available elements. In the embodiment, the first light source D1 and the second light source D2 are light-emitting diodes (LED). In another embodiment, the first light source D1 and the second light source D2 are LED arrays or other similar elements.

The first end, the second end and the third end of the first switch Q1 are base, collector and emitter respectively. The first end of the first switch Q1 is connected to the controller C; the second end of the first switch Q1 is connected to a driving power source V+; the third end of the first switch Q1 is connected to a first node N1.

The first end, the second end and the third end of the second switch Q2 are base, collector and emitter respectively. The first end of the second switch Q2 is connected to the controller C; the second end of the second switch Q2 is connected to the first node N1; the third end of the second switch Q2 is connected to a grounding point GND.

The first end, the second end and the third end of the third switch Q3 are base, collector and emitter respectively. The first end of the third switch Q3 is connected to the controller C; the second end of the third switch Q3 is connected to the driving power source V+; the third end of the third switch Q3 is connected to a second node N2.

The first end, the second end and the third end of the fourth switch Q4 are base, collector and emitter respectively. The first end of the fourth switch Q4 is connected to the controller C; the second end of the fourth switch Q4 is connected to the second node N2; the third end of the fourth switch Q4 is connected to the grounding point GND.

The light source group LD includes a first light source D1 and a second light source D2. In the embodiment, the first light source D1 and the second light source D2 are LEDs. The positive electrode of the first light source D1 and the negative electrode of the second light source D2 are connected to the first node N1; the negative electrode of the first light source D1 and the positive electrode of the second light source D2 are connected to the second node N2. In this way, the first light source D1 and the second light source D2 can be connected to each other in inverse parallel connection. In another embodiment, the first light source D1 and the second light source D2 may be LED arrays or other similar elements. In the embodiment, the color temperature of the first light source D1 is different from that of the second light source D2. In another embodiment, the color temperature of the first light source D1 is the same with that of the second light source D2.

As set forth above, the multi-function lighting device 1 can integrate the light source group LD, the first switch Q1, the second switch Q2, the third switch Q3 and the fourth switch Q4 with each other via a full-bridge circuit. Therefore, the above circuit structure can be driven by one driving power source V+ rather than multiple driving power sources. Thus, the cost of the multi-function lighting device 1 can be effectively decreased.

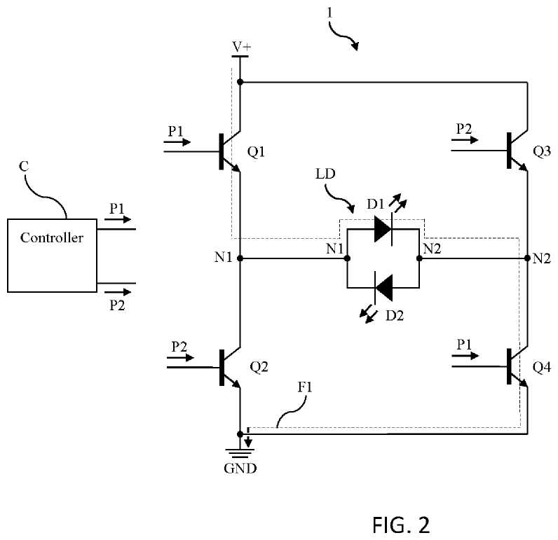

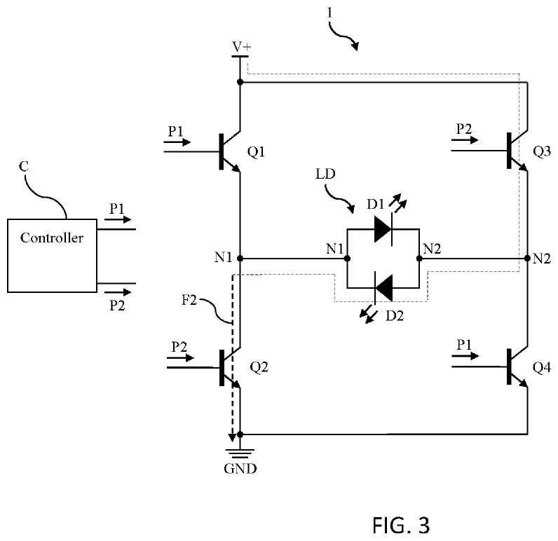

Please refer to FIG. 2 and FIG.3, which are a first schematic view and a second schematic view of an operational state of the multi-function lighting device in accordance with one embodiment of the present invention. FIG. 2 and FIG. 3 illustrate the operational mechanism of the multi-function lighting device 1. When the multi-function lighting device 1 is in the color temperature adjustment mode. As shown in FIG. 2, when the controller C generates a high-level first control signal P1 inputted into the first switch Q1 and the fourth switch Q4, the first switch Q1 and the fourth switch Q4 are turned on in order to turn on the first light source D1. Meanwhile, the driving current F1 passes through the driving power source V+, the first switch Q1, the first light source D1, the fourth switch Q4 and the grounding point GND. When the first control signal P1 is low-level, the first switch 01 and the fourth switch Q4 are turned off in order to turn off the first light source D1. The first control signal P1 may be a pulse-width modulation (PWM) signal.

As shown in FIG. 3, when the controller C generates a high-level second control signal P2 inputted into the second switch Q2 and the third switch Q3, the second switch Q2 and the third switch Q3 are turned on in order to turn on the second light source D2. Meanwhile, the driving current F2 passes through the driving power source V+, the third switch Q3, the second light source D2, the second switch Q2 and the grounding point GND. When the second control signal P2 is low-level, the second switch Q2 and the third switch Q3 are turned off in order to turn off the second light source D2. As described above, the waveform of the first control signal P1 is complementary to the waveform of the second control signal P2. In this case, when the first control signal P1 is high-level, the second control signal P2 is low-level; when the first control signal P1 is low-level, the second control signal P2 is high-level. Accordingly, only one of the first light source D1 and the second light source D1 is in on state. The second control signal P2 may be a PWM signal.

Moreover, when the multi-function lighting device 1 is in off state, the first control signal P1 and the second control signal P2 are low-level. In this case, the first switch Q1, the second switch Q2, the third switch Q3 and the fourth switch Q4 are turned off so as to turn off the first light source D1 and the second light source D2.

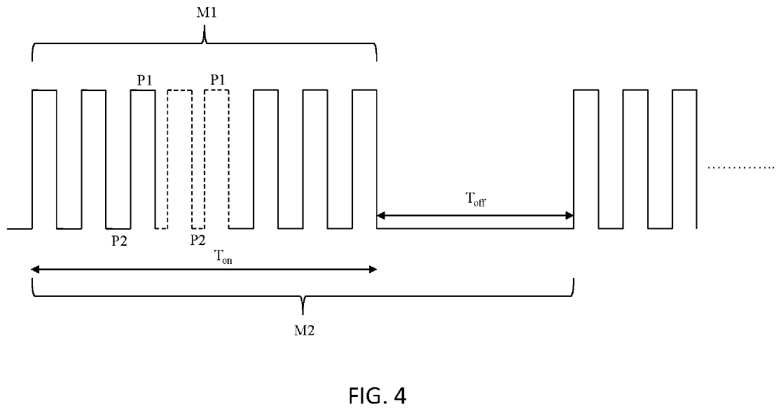

Please refer to FIG. 4, which is a schematic view for illustrating a first control signal and a second control signal of the multi-function lighting device in accordance with one embodiment of the present invention. As shown in FIG. 4, when the multi-function lighting device 1 is in the color temperature adjustment mode M1, the waveform of the first control signal P1 is complementary to that of the second control signal P2. Accordingly, the controller C can change the color temperature emitted by the light source group LD by adjusting the duty cycle of the first control signal P1 and/or the duty cycle of the second control signal P2 (in the embodiment, the duty cycle of the second control signal P2 is adjusted, as the dotted line shown in FIG. 4). Since the color temperature of the first light source D1 is different from that of the second light source D2, the controller C can switch the first switch Q1, the second switch Q2, the third switch Q3 and the fourth switch Q4 by a high frequency (e.g., 1 kHz, more than 1 kHz, 20 kHz or more than 20 kHz). In this way, the light emitted by the first light source D1 can be mixed with the light emitted by the second light source D2 to generate a mixed light. In addition, the controller C can change the color temperature of the mixed light by adjusting the duty cycle of the first control signal P1 and/or the duty cycle of the second control signal P2. As previously stated, since the controller C switch can switch the first switch Q1, the second switch Q2, the third switch Q3 and the fourth switch Q4 by the high frequency which is imperceptive for human eyes, the user cannot notice that the first light source D1 and the second light source D2 are continuously switched between on state and off state. However, the user can notice that the color temperature of the light source group LD changes.

When the multi-function lighting device 1 is in the brightness adjustment mode M2, the controller C adjusts the first control signal P1 and the second control signal P2 to change the off time Toff of the light source group LD with a view to adjust the brightness of the light emitted by the light source group LD. In this mode, the controller C does not change the duty cycles of the first control signal P1 and the second control signal P2 during the on time Ton of the light source group LD. For example, when the multi-function lighting device 1 is in the brightness adjustment mode M2 and the color temperature of the mixed light is the first color temperature, the controller C can control the first control signal P1 and the second control signal P2 to be low-level. Besides, the controller C can decrease the time of both the first control signal P1 and second control signal P2 being low-level (i.e., the off time Toff of the light source group LD) with a view to increase the brightness of the mixed light emitted by the light source group LD. On the contrary, the controller C can increase the time of both the first control signal P1 and the second control signal P2 being low-level (i.e., the off time Toff of the light source group LD) so as to reduce the brightness of the mixed light emitted by the light source group LD. As described above, since the controller C switch can switch the first switch Q1, the second switch Q2, the third switch Q3 and the fourth switch Q4 by the high frequency which is imperceptive for human eyes (e.g., 1 kHz, more than 1 kHz, 20 kHz or more than 20 kHz), the user cannot notice that the first light source D1 and the second light source D2 are continuously switched between on state and off state. However, the user can notice that the color temperature of the light source group LD changes.

The controller C can be connected to a coding switch with several buttons (e.g., EC11), and the user can switch the multi-function lighting device 1 between the color temperature adjustment mode M1 and the brightness adjustment mode M2 via the coding switch so as to adjust the color temperature or the brightness of the multi-function lighting device 1.

As set forth above, the multi-function lighting device 1 has the light source group LD having the first light source D1 and the second light source D2. The positive electrode of the first light source D1 and the negative electrode of the second light source D2 are connected to the first node N1, and the negative electrode of the first light source D1 and the positive electrode of the second light source D2 are connected to the second node N2. Thus, the first light source D1 and the second light source D2 can be connected to each other in inverse parallel connection. In this way, the controller C can adjust the first control signal P1 and the second control signal P2 in order to adjust the brightness and/or color temperature of the light source group LD. Accordingly, the multi-function lighting device 1 can provide both the brightness adjustment function and color temperature adjustment function. Besides, since the first light source D1 and the second light source D2 can be connected to each other in inverse parallel connection, the size of the light source group LD can be reduced. Therefore, the circuit board can have more space for other electronic components and wires.

The embodiment just exemplifies the present invention and is not intended to limit the scope of the present invention; any equivalent modification and variation according to the spirit of the present invention is to be also included within the scope of the following claims and their equivalents.

It is worthy to point out that a current available lighting device needs at least two driving power sources to provide both the stepless dimming function and color temperature adjustment function, so the circuit structure of this lighting device is complicated and the cost thereof is also significantly increased. On the contrary, according to one embodiment of the present invention, the multi-function lighting device includes the light source group having the first light source and the second light source. The positive electrode of the first light source and the negative electrode of the second light source are connected to the first node, and the negative electrode of the first light source and the positive electrode of the second light source are connected to the second node. Thus, the first light source and the second light source can be connected to each other in inverse parallel connection. In this way, the controller can adjust the first control signal and the second control signal (the waveform of the first control signal is complementary to the waveform of the second control signal) in order to adjust the brightness and/or color temperature of the light source group. Accordingly, the multi-function lighting device can provide both the brightness adjustment function and color temperature adjustment function.

Also, according to one embodiment of the present invention, the controller of the multi-function lighting device can adjust the first control signal and the second control signal by executing a software (the waveform of the first control signal is complementary to the waveform of the second control signal) so as to realize the stepless dimming function and/or the color temperature adjustment function. Therefore, the performance of the multi-function lighting device can be further enhanced.

Further, according to one embodiment of the present invention, the light source group of the multi-function lighting device has a first light source and a second light source connected to each other in inverse parallel connection. Thus, the size of the light source group can be reduced, such that the circuit board can have more space for other electronic components and wires.

Moreover, according to one embodiment of the present invention, the multi-function lighting device can integrate the light source group, the first switch, the second switch, the third switch and the fourth switch with each other via a full-bridge circuit. Therefore, the above circuit structure can be driven by one driving power source rather than multiple driving power sources. Thus, the cost of the multi-function lighting device can be further decreased.

Furthermore, in one embodiment of the present invention, the multi-function lighting device can be driven by one driving power source rather than multiple driving power sources. Therefore, the cost of the multi-function lighting device can be effectively decreased, so the multi-function lighting device can achieve great market competitiveness. As described above, the multi-function lighting device according to the embodiments of the present invention can definitely achieve great technical effects.

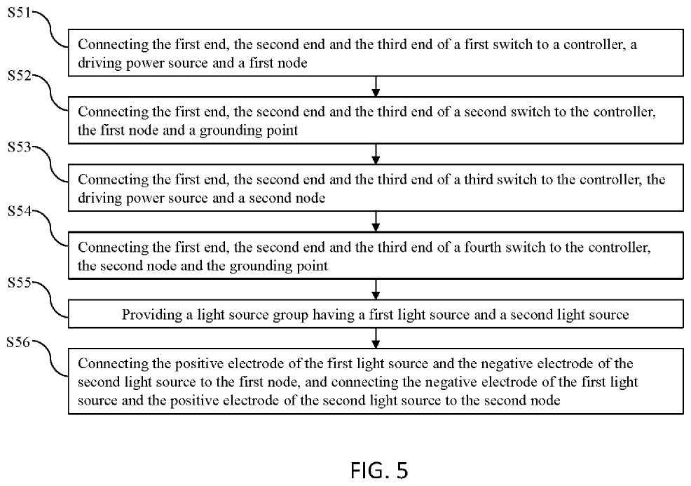

Please refer to FIG. 5, which is a flow chart of a manufacturing method of the multi-function lighting device in accordance with one embodiment of the present invention. The manufacturing method of the multi-function lighting device 1 according to the embodiment includes the following steps:
Step S51: connecting the first end, the second end and the third end of a first switch to a controller, a driving power source and a first node.
Step S52: connecting the first end, the second end and the third end of a second switch to the controller, the first node and a grounding point.
Step S53: connecting the first end, the second end and the third end of a third switch to the controller, the driving power source and a second node.
Step S54: connecting the first end, the second end and the third end of a fourth switch to the controller, the second node and the grounding point.
Step S55: providing a light source group having a first light source and a second light source.
Step S56: connecting the positive electrode of the first light source and the negative electrode of the second light source to the first node, and connecting the negative electrode of the first light source and the positive electrode of the second light source to the second node.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the present invention, the multi-function lighting device includes the light source group having the first light source and the second light source. The positive electrode of the first light source and the negative electrode of the second light source are connected to the first node, and the negative electrode of the first light source and the positive electrode of the second light source are connected to the second node. Thus, the first light source and the second light source can be connected to each other in inverse parallel connection. In this way, the controller can adjust the first control signal and the second control signal (the waveform of the first control signal is complementary to the waveform of the second control signal) in order to adjust the brightness and/or color temperature of the light source group. Accordingly, the multi-function lighting device can provide both the brightness adjustment function and color temperature adjustment function.

Also, according to one embodiment of the present invention, the controller of the multi-function lighting device can adjust the first control signal and the second control signal by executing a software (the waveform of the first control signal is complementary to the waveform of the second control signal) so as to realize the stepless dimming function and/or the color temperature adjustment function. Therefore, the performance of the multi-function lighting device can be further enhanced.

Further, according to one embodiment of the present invention, the light source group of the multi-function lighting device has a first light source and a second light source connected to each other in inverse parallel connection. Thus, the size of the light source group can be reduced, such that the circuit board can have more space for other electronic components and wires.

Moreover, according to one embodiment of the present invention, the multi-function lighting device can integrate the light source group, the first switch, the second switch, the third switch and the fourth switch with each other via a full-bridge circuit. Therefore, the above circuit structure can be driven by one driving power source rather than multiple driving power sources. Thus, the cost of the multi-function lighting device can be further decreased.

Furthermore, in one embodiment of the present invention, the multi-function lighting device can be driven by one driving power source rather than multiple driving power sources. Therefore, the cost of the multi-function lighting device can be effectively decreased, so the multi-function lighting device can achieve great market competitiveness.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-function lighting device, comprising:
a controller;
a first switch, wherein a first end, a second end and a third end thereof are connected to the controller, a driving power source and a first node respectively;
a second switch, wherein a first end, a second end and a third end thereof are connected to the controller, the first node and a grounding point respectively;
a third switch, wherein a first end, a second end and a third end thereof are connected to the controller, the driving power source and a second node respectively;
a fourth switch, wherein a first end, a second end and a third end thereof are connected to the controller, the second node and the grounding point respectively; and
a light source group, comprising a first light source and a second light source, wherein a positive electrode of the first light source and a negative electrode of the second light source are connected to the first node, and a negative electrode of the first light source and a positive electrode of the second light source are connected to the second node.

2. The multi-function lighting device as claimed in claim 1, wherein the first switch, the second switch, the third switch and the fourth switch are bipolar junction transistors.

3. The multi-function lighting device as claimed in claim 1, wherein the controller is a microcontroller unit, a central-processing unit, an application specific integrated circuit or a field programmable gate array.

4. The multi-function lighting device as claimed in claim 1, wherein the controller is a microcontroller unit, a central-processing unit, an application specific integrated circuit or a field programmable gate array.

5. The multi-function lighting device as claimed in claim 4, wherein when a second control signal, generated by the controller, inputted into the second switch and the third switch is high-level, the second switch and the third switch are turned on so as to turn on the second light source, wherein when the second control signal is low-level, the second switch and the third switch are turned off so as to turn off the second light source.

6. The multi-function lighting device as claimed in claim 5, wherein a waveform of the first control signal is complementary to a waveform of the second control signal.

7. The multi-function lighting device as claimed in claim 5, wherein the first control signal and the second control signal are pulse-width modulation signals.

8. The multi-function lighting device as claimed in claim 5, wherein the controller adjusts the first control signal and the second control signal to change an off time of the light source group in order to adjust a brightness of the light source group.

9. The multi-function lighting device as claimed in claim 5, wherein the controller adjusts a duty cycle of the first control signal and/or a duty cycle of the second control signal in order to change a color temperature of a light emitted by the light source group.

10. The multi-function lighting device as claimed in claim 1, wherein the first light source and the second light source are light-emitting diodes or light-emitting diode arrays.
